(19) United States
(12) Patent Application Publication
(10) Pub. No.: US 2025/0363906 A1
(43) Pub. Date: Nov. 27, 2025

(54) DYNAMICALLY ADJUSTING CONTENT DELIVERY DURING AN ONLINE LEARNING SESSION FOR OPTIMIZED LEARNING AND USER ENGAGEMENT

(71) Applicant: 2hr Learning, Inc., Austin, TX (US)

(72) Inventors: Philip Hewinson, Woking (GB); Samy Aboel-Nil, Austin, TX (US)

(73) Assignee: 2hr Learning, Inc., Austin, TX (US)

(21) Appl. No.: 19/218,319

(22) Filed: May 25, 2025

Related U.S. Application Data
(60) Provisional application No. 63/652,137, filed on May 27, 2024.

(51) Int. Cl. G09B 7/04; G06F 16/9535; G09B 7/08

(52) U.S. Cl. CPC G09B 7/04; G06F 16/9535; G09B 7/08

(57) ABSTRACT

The system and method to present a variety of content items during an online learning session to enhance user engagement are disclosed. The user engagement data is accessed via an engagement analysis module integrated within optimized content delivery system. The engagement data includes interactions of user with the content during the online learning session, content history, session duration, and preferences. The user engagement data is processed via the engagement analysis module to predict user engagement patterns during the online learning session. The content items are optimized via an optimization module. The optimizing the content item includes determining sequence of content items to be presented to the user during the online learning session, shuffling the content items, and adjusting the difficulty levels of the content items based on user's proficiency level and historical performance data. Finally, users receive sequentially customized content items, providing user engagement and enhancing the learning process.

### CROSS-REFERENCE TO RELATED APPLICATION

This application claims the benefit under 35 U.S.C. § 119(e) and 37 C.F.R. § 1.78 of U.S. Provisional Application No. 63/652,137, filed May 27, 2024, which is incorporated by reference in its entirety.

### FIELD OF THE INVENTION

The present invention relates in general to the field of electronics, and more specifically to a system and method for dynamically adjusting and presenting different content items to a user during an online learning session to optimize learning experience and user engagement.

### BACKGROUND OF THE INVENTION

Engagement is crucial for student's learning and satisfaction in online courses. Student engagement increases student satisfaction, enhances student motivation to learn, reduces the sense of isolation, and improves student performance in online courses. Student engagement in online learning is very important because online learners seem to have fewer opportunities to be engaged with the institution. Hence, it is essential to create multiple opportunities for student engagement in the online environment. Engagement strategies are aimed at providing positive learner experiences including active learning opportunities, such as participating in collaborative group work, having students facilitate presentations and discussions, sharing resources actively, creating course assignments with hands-on components, and integrating case studies and reflections.

Conventional educational techniques rely substantially on static text-based materials or simple video lectures. Such static content delivery approach lack interactivity and diverse learning styles and preferences of students. These techniques are also limited in their ability to maintain student engagement over extended periods, leading to a monotonous learning experience that could result in decreased motivation and retention of information.

Some educational institutions attempted to address the abovementioned gaps by incorporating multimedia elements such as images and videos into educational content. While this adds a visual component in the content, the technique may not be able to fully engage the learners or students. Some platforms introduced basic quizzes and flashcards, but these tools often lacked depth and may not provide a comprehensive, varied learning experience. Additionally, the content may not align with user's performance, leading to a one-size-fits-all approach that may either overwhelm or under-challenge students.

Therefore, there is a need for an advanced educational system that can deliver a more engaging, interactive, and personalized learning experience to users such as students.

### SUMMARY

A method to present a variety of content items during an online learning session to enhance user engagement includes executing code using one or more processors of a computer system to cause the computer system to perform operations that includes accessing user engagement data via an engagement analysis module integrated with an optimized content delivery system, wherein the engagement data include user's interaction with the content during the online learning session, user's content interaction history, session duration, and content type. The method also includes processing the user engagement data to predict user engagement patterns during the online learning session. The method includes optimizing the content items to be presented during the online learning session via an optimization module, wherein optimizing the content items includes determining sequence of content items to be presented to the user during the online learning session, shuffling the content items, and adjusting the difficulty levels of the content items based on user's proficiency level and historical performance data. The method also includes receiving the optimized content items customized based on the user's learning history, preferences, and real-time engagement to create a personalized learning experience.

A system to present a variety of content items during an online learning session to enhance user engagement includes one or more processors and a memory, coupled to the one or more processors, having code stored therein that, when executed by the one or more processors, causes the one or more processors to perform operations. The operation includes accessing user engagement data via an engagement analysis module integrated with an optimized content delivery system, wherein the engagement data include user's interaction with the content during the online learning session, user's content interaction history, session duration, and content type. The system also includes processing the user engagement data to predict user engagement patterns during the online learning session. The system includes optimizing the content items to be presented during the online learning session via an optimization module, wherein optimizing the content items includes determining sequence of content items to be presented to the user during the online learning session, shuffling the content items, and adjusting the difficulty levels of the content items based on user's proficiency level and historical performance data. The system also includes receiving the optimized content items customized based on the user's learning history, preferences, and real-time engagement to create a personalized learning experience.

### BRIEF DESCRIPTION OF THE DRAWINGS

The systems and methods described herein may be better understood, and their numerous objects, features, and advantages are made apparent to those skilled in the art by referencing exemplary embodiments depicted in the accompanying figures. The use of the same reference number throughout the several figures designates a like or similar element.

FIG. 1 depicts an exemplary system for an integrated user engagement and content delivery system for the user in an online learning platform to provide optimized and engaged learning to the user.

FIG. 2 depicts an exemplary process for an integrated user engagement and content delivery system for the user in an online learning platform to provide optimized and engaged learning to the user.

FIG. 3 depicts a flow chart showing the details of the steps involved in the process of an integrated user engagement and content delivery system for the user in an online learning platform to provide optimized and engaged learning to the user.

FIG. 4 depicts a sequence diagram disclosing the delivery of mixed content items to optimize user learning and engagement, which is an embodiment of the integrated user engagement and content delivery process of FIG. 2.

FIG. 5 depicts a sequence diagram disclosing the content variety optimization for enhanced learning engagement, which is an embodiment of the integrated user engagement and content delivery process of FIG. 2.

FIGS. 6-8 depict exemplary user interfaces of an online learning platform disclosing a variety of content items provided to the user, which is an embodiment of the integrated user engagement and content delivery process of FIG. 2.

FIG. 9 depicts an exemplary view of the user interface of an online learning platform where a real-time tutor provides adaptive learning to the user.

FIG. 10 depicts a diagram showing the delivery of mixed content items to optimize user learning and engagement.

FIG. 11 depicts a diagram showing the content variety optimization for enhanced learning engagement.

FIG. 12 depicts an exemplary network environment in which the integrated user engagement and content delivery system of FIG. 1 and the integrated user engagement and content delivery process of FIG. 2 may be practiced.

FIG. 13 depicts an exemplary computer system.

### DETAILED DESCRIPTION

An integrated user engagement and content delivery system presents a variety of optimized content within an online learning session to enhance user engagement. The integrated user engagement and content delivery system provides mixed content items and delivers them to a user attending the online learning session on an online learning platform. The integrated user engagement and content delivery system includes a memory operatively coupled to one or more processors which consists of one or more codes that when executed causes the one or more processors to execute the operations.

An engagement analysis module integrated with an optimized content delivery system accesses the user profile and collects the user engagement data in real-time. The real-time user engagement data include user interactions with the online learning platform, content interaction history, session duration, and content type. The engagement analysis module using collected engagement metrics to predict engagement patterns of the user during the online session. The optimize content delivery system generates the shuffled and mixed content items for the user. An optimization module optimizes the content items to be presented during the online learning session. The optimizing the content items includes determining sequence of content items to be presented to the user during the online learning session, shuffling the content items, and adjusting the difficulty levels of the content items based on user's proficiency level and historical performance data. The optimized content items customized based on the user's learning history, preferences, and real-time engagement to create a personalized learning experience is received.

The integrated user engagement and content delivery system offers a significant advantage by creating a highly personalized and adaptive learning experience that effectively maintains user engagement and optimizes learning outcomes. The integrated user engagement and content delivery system can dynamically adjust content sequences, balance interactive and non-interactive segments, and tailor difficulty levels to individual needs. This adaptive approach prevents cognitive overload, addresses varying learning styles, and continuously aligns content with the user's evolving preferences and performance. As a result, users are more likely to stay motivated and achieve increased engagement, making the learning process both efficient and enjoyable.

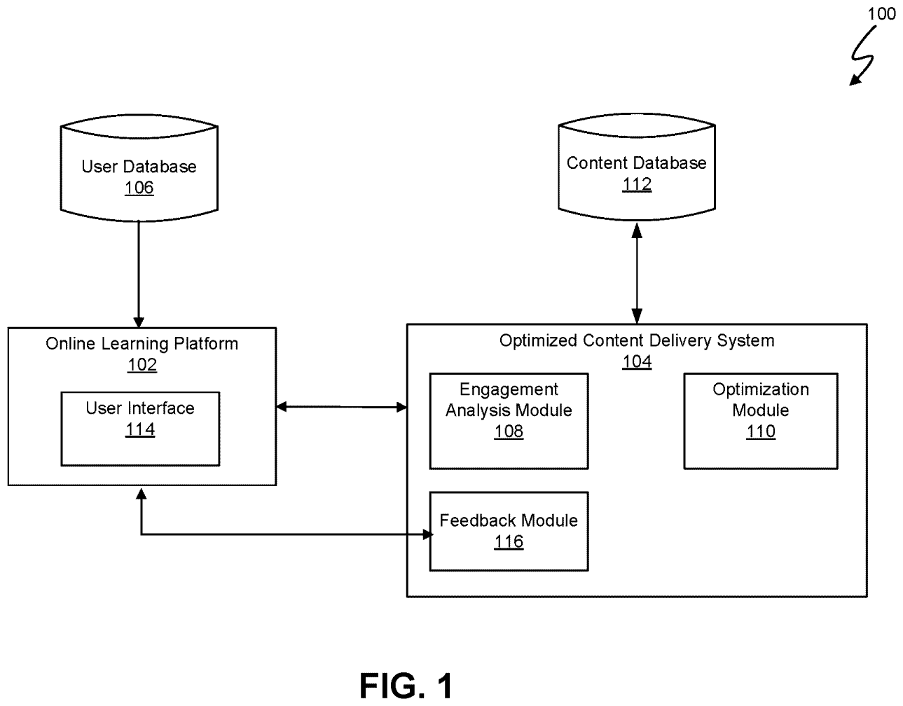

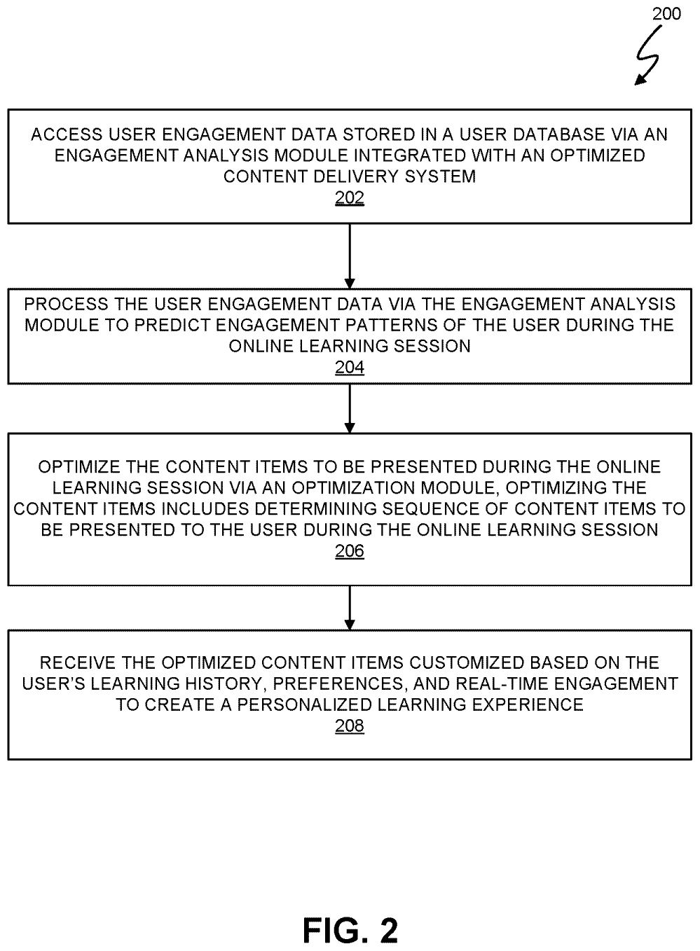

FIG. 1 depicts an exemplary integrated user engagement and content delivery system 100 for the user in an online learning platform 102 to provide optimized and engaged learning to the user. FIG. 2 depicts an exemplary integrated user engagement and content delivery process 200 for the user in the online learning platform 102 to provide optimized and engaged learning to the user, utilized by the integrated user engagement and content delivery system 100.

An integrated user engagement and content delivery system 100 includes an optimized content delivery system 104 to utilize a variety of optimized content items within online learning sessions in the online learning platform 102 to enhance user engagement. The optimized content delivery system 104 generates mixed content items and delivers them to the user attending the online learning session in the online learning platform 102. The Integrated user engagement and content delivery system 100 includes a user database 106 operatively coupled to the online learning platform 102 for storing the user data associated with the user engagement on the online learning platform 102.

Referring to FIGS. 1 and 2, in operation 202, a user engagement data stored in a user database 106 is accessed via an engagement analysis module 108 integrated with an optimized content delivery system 104. The engagement data includes user interactions with the online learning platform 102, content interaction history, session duration, and content type. The engagement analysis module 108 is used to access and collect user profile details in real-time. The user engagement data includes user interactions with the online learning platform 102, content interaction history, session duration, and content type.

The content items within the integrated user engagement and content delivery system 100 incorporate a diverse array of types, deliberately designed to provide to various learning preferences and styles. The content items include a mix of academic and non-academic materials, ensuring a well-rounded learning experience. Among the academic content are traditional formats like multiple-choice questions and fill-in-the-blanks, which offer structured assessments of knowledge acquisition. Additionally, the integrated user engagement and content delivery system 100 incorporates interactive elements such as matching pairs, encouraging active engagement and critical thinking. Beyond these conventional formats, the integrated user engagement and content delivery system 100 incorporates innovative approaches such as truth or lies challenges, what's my name audio tasks, controversial conversations, did you know segments, and explanatory videos. These inventive formats serve to stimulate interest, enhance user engagement, and accommodate different learning modalities, ensuring that users remain engaged and motivated throughout their online learning sessions. The non-interactive content segments including informative videos, explanatory text, or visual aids that provide supplementary information related to the learning objectives and are informative and engaging, offering users valuable insights into the subject matter without requiring active user participation.

In at least one embodiment, the optimized content delivery system 104 balances the ratio of interactive to non-interactive content segments, the user engagement is optimized, and the risk of cognitive overload is eliminated, thus providing an engaging and adaptive learning environment. Based on the user engagement data, the ratio of the interactive to non-interactive content may be changed. For example, in one online learning session, the ratio may be 60% and 40%, where 60% content is related to non-interactive content segments and 40% is interactive content segments.

In operation 204, the user engagement data is processed by the engagement analysis module 108 to predict engagement patterns of the user during learning sessions.

The engagement analysis module 108 utilizes the collected user engagement data to make informed predictions about user engagement patterns. The engagement data include data on how users interact with the content, their preferences, and their performance. The integrated user engagement and content delivery system 100 then uses the engagement analysis module to analyze and predict user engagement trends. Based on these predictions, the engagement analysis module 108 identifies the user engagement and enables in optimizing the variety of content presented during the learning sessions. Typically, optimization process involves selecting and adjusting the content types and difficulty levels to keep the user engaged. By continuously adapting the content in real-time, the integrated user engagement and content delivery system 100 ensures that the learning experience remains dynamic, personalized, and engaging, thus preventing fatigue and cognitive overload. This iterative approach allows the online learning platform 102 to fulfil individual learning needs and preferences, enhancing overall user satisfaction and learning outcomes.

The process of customizing the sequence of content items within an online learning platform 102 is essential for delivering an effective and personalized educational experience. It begins with the continuous update of user details stored in the user database 106, which captures the evolving interactions and preferences of each learner. By maintaining accurate user profile, the integrated user engagement and content delivery system 100 gains insights into the user's progress, learning history, and content preferences, laying the foundation in correspondence to the user's learning experiences.

Once the user profile are updated in the user database 106, the integrated user engagement and content delivery system 100 analyzes these profiles comprehensively using the engagement analysis module 108. The engagement analysis module 108 collects the user profile and user engagement data and analyzes them using based on various aspects of the user's preferences, including favored content types, preferred learning styles, and desired difficulty levels. Each time the user interacts with the online learning platform 102, data regarding their engagement, performance, and feedback is gathered and fed into the engagement analysis module 108. This data includes information about which content types are most engaging, how different difficulty levels affect user performance, and what user preferences are in terms of learning styles and content formats.

In operation 206, the content item to be presented to the user during the online learning session is optimized via an optimization module 110. The optimizing the content items includes determining sequence of content items to be presented to the user during the online learning session, shuffling the content items, and adjusting the difficulty levels of the content items based on user's proficiency level and historical performance data.

The optimization module 110 ensures that the shuffling of content items and the sequencing of their presentation are effectively coordinated and optimized to enhance the user's learning experience. The optimization module 110 can dynamically adjust the sequence of content items based on real-time user interactions and feedback, thereby offering a personalized and adaptive learning pathway. This cohesive integration allows for the efficient processing of content items and ensures that users receive a learning experience that aligns with their preferences and learning objectives.

The optimization module 110 arranges the sequence of content items in online learning sessions on the online learning platform 102 by analyzing the real-time user engagement data collected from user interactions. By decoding patterns and behaviors, the engagement analysis module 108 gains insights into individual learning preferences and objectives. Subsequently, the optimization module 110 utilizes this understanding to curate a selection of content items from a content database 112. These selections are made with careful consideration of various factors including content type, difficulty level, and alignment with the user's learning goals.

Next, the chosen content items are sequenced in an order optimized to enhance the user's learning experience. This optimization involves the optimization module 110 to shuffle the content items through different content types and adjust difficulty levels dynamically. Throughout the online learning session, the optimized content delivery system 104 continuously monitors user interactions and feedback, allowing for real-time adjustments to the content. This adaptive approach ensures that the content remains relevant and engaging, thereby maximizing the effectiveness of the online learning session.

The optimization module 110 is designed to dynamically adjust the sequence of content items based on ongoing engagement analysis, ensuring that the user remains continuously engaged and preventing content fatigue. This functionality involves real-time assessment of how users interact with different types of content, including their levels of interest, performance, and feedback. By analyzing these engagement data, the optimization module 110 can reorder content to maintain optimal interest and engagement levels. For instance, if a user shows signs of waning attention or struggles with certain types of content, the optimization module 110 might introduce a different type of content, such as switching from a series of difficult multiple-choice questions to a more engaging interactive activity or an interesting video segment. This dynamic sequencing helps to keep the learning experience varied and stimulating, reducing the likelihood of content fatigue and ensuring that the user's learning journey remains effective and enjoyable.

In operation 208, the optimized content items are received based on the user's learning history, preferences, and real-time engagement to create a personalized learning experience.

The process of updating the user's preferences in real-time within the online learning platform 102 is essential for ensuring that the content selection remains relevant and aligned with the user's evolving learning needs and interests. This dynamic updating mechanism continuously tracks the user's interactions with the online learning platform 102, including the user engagement with different types of content items, the duration of their sessions, and any feedback provided during or after the learning experience. By analyzing these ongoing interactions, the optimized content delivery system 104 can adaptively adjust the content selection process to better suit the user's preferences and learning goals. The optimized content items are delivered on a user interface 114 of the online learning platform 102.

Additionally, a feedback module 116 is integrated into the integrated user engagement and content delivery system 100 to collect direct input from users regarding various aspects of their learning experience. The feedback module 116 solicits feedback on factors such as content relevance, engagement levels, and perceived difficulty, allowing users to provide valuable insights into their preferences and learning preferences. The feedback collected through the feedback module 116 is then used to iteratively improve the sequencing capabilities of the integrated user engagement and content delivery system 100. By utilizing user feedback in this way, the integrated user engagement and content delivery system 100 can refine its content selection process over time, enhancing the overall quality and effectiveness of the learning experience for each user.

In an embodiment, in the integrated user engagement and content delivery system 100 the method of combining interactive content with non-interactive content within the online learning session is designed to optimize user engagement and mitigate mental fatigue. The optimized content delivery system 104 identifies opportune moments within the online learning session to introduce non-interactive content segments. These breakpoints are determined based on various factors such as the duration of the session, the user's engagement levels, and the complexity of the content being presented.

Once these breakpoints are identified, the optimized content delivery system 104 delivers non-interactive content segments to the user at strategic intervals. The frequency of these interruptions is carefully calibrated based on factors such as user preferences, session goals, and learning objectives. By providing periodic breaks from interactive content, the optimized content delivery system 104 aims to prevent cognitive overload and maintain the user's attention and focus throughout the session.

Furthermore, the optimized content delivery system 104 continuously monitors the user's response to these non-interactive content segments. This includes assessing the user's engagement levels, tracking any changes in attention or interest, and gathering feedback on the overall impact of the breaks on their learning experience. By incorporating user feedback, the optimized content delivery system 104 can refine its approach to combining interactive and non-interactive content, ultimately enhancing the user's overall learning journey and mitigating mental fatigue effectively.

The below pseudo-code is utilized by the integrated user engagement and content delivery system 100. The integrated user engagement and content delivery system 100 utilizes the engagement analysis module 108 and optimization module 110. The engagement analysis module 108 processes the user engagement data to predict engagement patterns of the user during the online learning session. The optimization module 110 optimizes the content items to be presented during the online learning session.

```
# Function to deliver a mix of content for learning and engagement
def deliver_content_mix(user_profile, content_database):
  “““
  This function takes the user's profile and the content database
as input.
  It delivers a mix of content based on the user's learning history
and preferences.
  ”””
  # Initialize an empty list to store the content mix for the
session
  content_mix = [ ]
  # Define the distribution of content types
  content_distribution = {
    ‘academic_interactive’: 0.66, # 2/3rd of the content is
academic interactive
    ‘non_academic’: 0.34 # 1/3rd of the content is non-academic
  }
  # Fetch user's learning history and preferences from the user
profile
  learning_history = user_profile.ge_learning_history( )
  preferences = user_profile.get_preferences( )
  # Fetch content from the database based on the user's current
mastery level
  academic_content =
content_database.get_academic_content(learning_history, preferences)
  non_academic_content =
content_database.get_non_academic_content(learning_history,
preferences)
  # Calculate the number of content items based on the distribution
  num_academic = int(len(academic_content) *
content_distribution[‘academic_interactive’])
  num_non_academic = int(len(non_academic_content) *
content_distribution[‘non_academic’])
  # Select content items based on the calculated numbers
  selected_academic_content = academic_content[:num_academic]
  selected_non_academic_content =
non_academic_content[:num_non_academic]
  # Combine the selected academic and non-academic content
  content_mix.extend(selected_academic_content)
  content_mix.extend(selected_non_academic_content)
  # Shuffle the content mix to avoid predictability and enhance
engagement
  random.shuffle(content_mix)
  # Return the final content mix for the learning session
  return content_mix
# Call the function with a user profile and content database
user_profile = UserProfile( ) # Assume UserProfile is a class that
manages user data
content_database = ContentDatabase( ) # Assume ContentDatabase is a
class that manages content data
session_content = deliver_content_mix(user_profile, content_database)
# Output the session content for the user
for content in session_content:
  display(content) # Assume display is a function that shows
content to the user
```

The function deliver_content_mix generates a personalized and engaging mix of academic and non-academic content for the user by leveraging their learning history and preferences. The function deliver_content_mix begins by defining a target distribution suh as, two-thirds academic interactive and one-third non-academic and retrieves matching content from the content database 112 based on the user's mastery level. then calculates the appropriate number of items to select from each type, slices the relevant portions of academic and non-academic content, combines them, and shuffles the result to ensure variety. Finally, it returns the mixed content list to be used in a learning session.

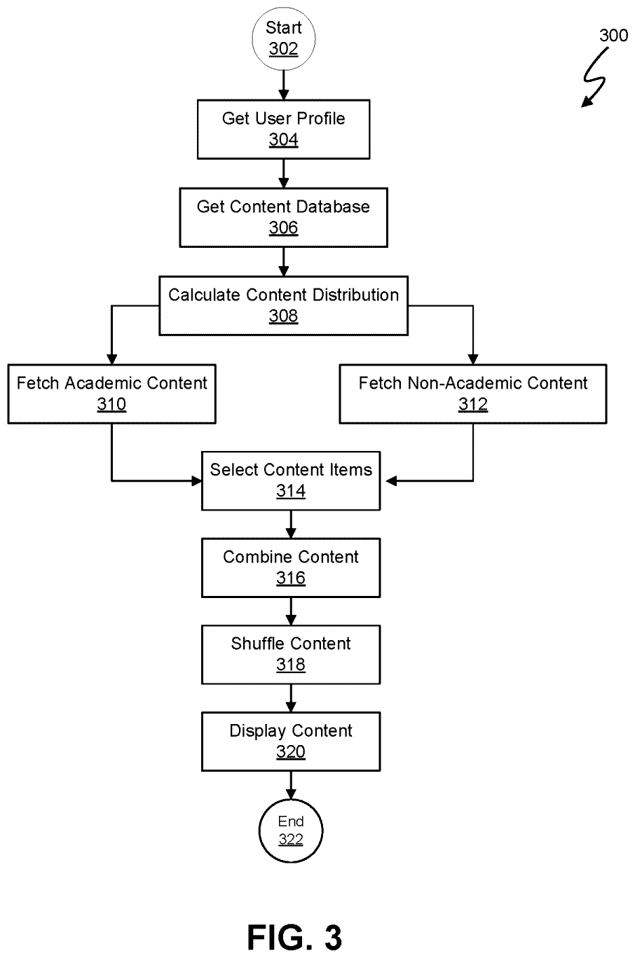

FIG. 3 depicts a flow chart 300 showing the details of the steps involved in the process of the integrated user engagement and content delivery system 100 for the user in an online learning platform 102 to provide optimized and engaged learning to the user.

The flow chart 300 disclosing the process of the integrated user engagement and content delivery system 100 for the user in an online learning platform 102 to provide optimized and engaged learning to the user starts when a user initiates an online learning session 302 by accessing the online learning platform 102 by logging on to a user profile. This action triggers the integrated user engagement and content delivery system 100 to retrieve the user's profile 304, which includes essential information such as the user's learning history and preferences.

Next, the integrated user engagement and content delivery system 100 accesses the content database 112, which contains a variety of both academic and non-academic content 306. With the user profile and content database 112 in hand, the integrated user engagement and content delivery system 100 distribution calculation 308 of content types to be delivered during the online learning session. This calculation follows a predefined ratio where 66% of the content is academic, and 34% is a mixture of non-academic, interactive, and non-interactive. Following the content distribution calculation 308, the integrated user engagement and content delivery system 100 fetches the appropriate content from the content database 112 and retrieves academic content first 310, aligning with the user's learning history and preferences to ensure relevance and engagement. Similarly, the integrated user engagement and content delivery system 100 fetches non-academic content 312 based on the same criteria.

After fetching the content, the integrated user engagement and content delivery system 100 selects specific content items 314 according to the calculated numbers. For instance, if the academic content list contains hundred items, and the distribution ratio requires two-thirds of the content to be academic, the integrated user engagement and content delivery system 100 selects around 66 academic items. Likewise, it selects one-third of the non-academic content. These selected content items are then combined into a single list 316, integrating both academic and non-academic content. To enhance the learning experience and avoid predictability, the integrated user engagement and content delivery system 100 shuffles 318 the combined content, ensuring a randomized and engaging content flow.

Finally, the shuffled content is displayed to the user 320 on the user interface 114 integrated within the online learning platform 102. This step involves presenting the various content items seamlessly and engagingly, in correspondence to the user's profile. The online learning session 322 concludes after the user has engaged with the delivered content items, marking the end of the online learning session 322. This detailed process ensures a personalized, engaging, and effective learning experience for each user.

Let's explain the whole process mentioned in the flow chart 300 using an example involving a high school student named Lisa. Lisa initiates her study session by logging into an online learning platform 102. The integrated user engagement and content delivery system 100 begins by retrieving Lisa's user profile, which contains information on her historical performance and learning preferences. With this data, the integrated user engagement and content delivery system 100 accesses its content database 112, which includes historical materials ranging from articles to interactive timelines.

Upon accessing the content database 112, the integrated user engagement and content delivery system 100 calculates the distribution of content based on Lisa's profile, identifying her preference for a blend of interactive and reading-based materials. Subsequently, it fetches both academic and non-academic content, ensuring a comprehensive selection that aligns with Lisa's interests and study goals. For instance, academic content could include articles on pivotal historical events, while non-academic content might consist of educational videos or interactive timelines.

Following content retrieval, the integrated user engagement and content delivery system 100 selects specific items tailored to Lisa's needs and preferences, merging them into a cohesive content mix. This mix undergoes shuffling to maintain engagement and variety throughout Lisa's online learning session. Once curated, the content is displayed to Lisa, allowing her to interact with the materials seamlessly.

Upon completion of her session, the integrated user engagement and content delivery system 100 provides Lisa with a summary of her performance, including areas of strength and improvement. By using this process, the online learning platform 102 offers Lisa a personalized and enriching learning experience that nurtures her historical comprehension and retention.

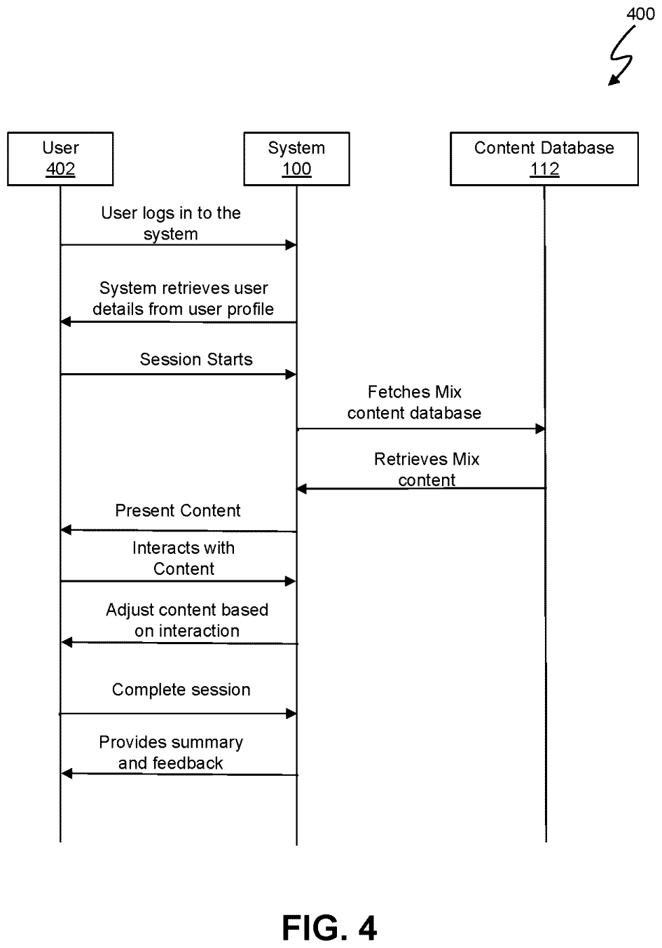

FIG. 4 depicts a sequence diagram 400 disclosing the delivery of mixed content items to optimize user learning and engagement, which is an embodiment of the integrated user engagement and content delivery process 200 of FIG. 2.

The sequence diagram 400 depicts a detailed interaction between a user 402 and the online learning platform 102, outlining each step of the online learning session. The sequence diagram 400 illustrates an exemplary scenario where the details of the interaction between Alex, a high school student, and the online learning platform 102 are designed to optimize his online learning sessions for a science exam. The process begins with Alex logging into the online learning platform 102, which immediately accesses his stored performance data from previous sessions stored in the user database 106. This initial step ensures that the integrated user engagement and content delivery system 100 and has up-to-date information on Alex's learning progress and mastery levels.

Upon logging in, Alex starts a new online learning session. Once logged in, the integrated user engagement and content delivery system 100 immediately begins analyzing Alex's past interactions and his current mastery level in various science topics. This analysis allows the integrated user engagement and content delivery system 100 to modify the learning experience specifically to Alex's needs. Based on the insights gained from the analysis, the integrated user engagement and content delivery system 100 to select a variety of content for Alex's online learning session. The content is carefully chosen to ensure a balance between different types of questions and interactive formats. For example, the integrated user engagement and content delivery system 100 might include a mix of multiple-choice questions (MCQs), fill-in-the-blank (FITB) questions, and engaging formats like “truth or lies” to keep Alex interested and motivated.

The integrated user engagement and content delivery system 100 responses by querying its content database 112 to fetch a mix of educational content tailored to Alex's needs. This content mix is not arbitrary. The content database 112 includes a variety of question types and interactive formats, such as multiple-choice questions (MCQs), fill-in-the-blank (FITB) questions, and engaging formats like “truth or lies” and “what's my name” challenges. This variety is crucial for maintaining Alex's interest and providing a comprehensive learning experience.

As the session progresses, the integrated user engagement and content delivery system 100 presents this diverse set of content to Alex. His interactions with the material are monitored in real-time. The online learning platform 102 adjusts the difficulty and type of content based on Alex's responses and engagement levels, ensuring that the session remains challenging yet manageable. This adaptive capability is a key feature of the integrated user engagement and content delivery system 100 to dynamically adjust the mixed content items, differentiating it from static, one-dimensional educational approaches.

At the end of the session, the integrated user engagement and content delivery system 100 provides Alex with a detailed summary of his performance. This summary highlights areas where Alex has shown improvement and identifies topics that may require further study. This feedback loop not only reinforces learning but also helps Alex focus his future study efforts more effectively.

Overall, the sequence diagram 400 illustrates a dynamic and interactive learning process that utilizes past performance data to create personalized and engaging online learning sessions. This method enhances the user's learning experience by maintaining his interest and providing continuous, adaptive feedback.

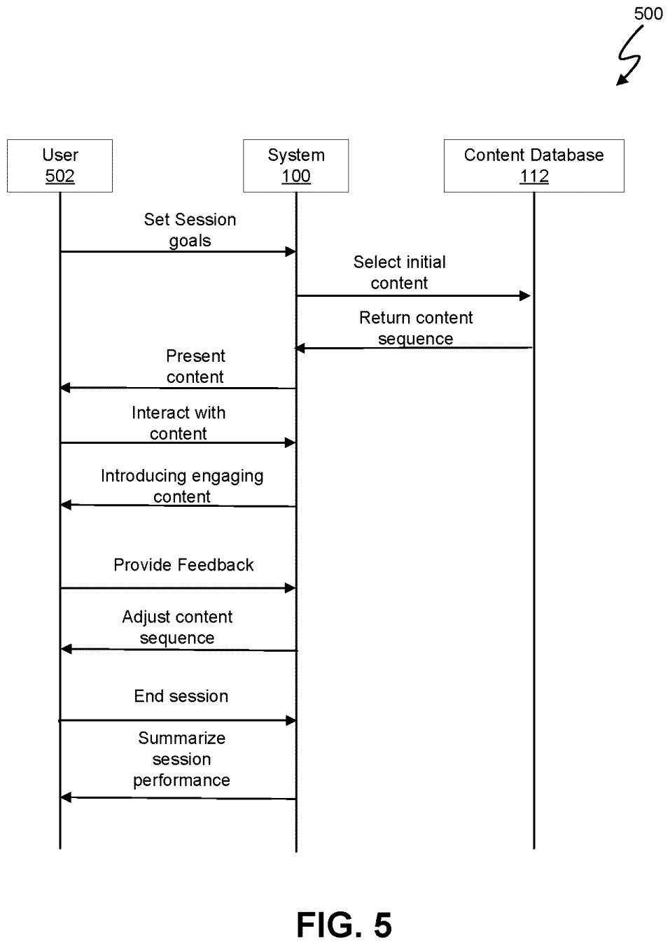

FIG. 5 depicts a sequence diagram 500 disclosing the content variety optimization for enhanced learning engagement, which is an embodiment of the integrated user engagement and content delivery process 200 of FIG. 2.

The sequence diagram 500 adaptively provides content that aligns with user's engagement levels and learning preferences, providing a personalized and effective study experience that significantly enhances and engages the user 502 during the online learning sessions. The sequence diagram 500 discloses a personalized and adaptive learning process for a user 502 on the online learning platform 102. The user begins by setting session goals and available study time. The integrated user engagement and content delivery system 100 then selects and retrieves a sequence of content items from the content database 112, including interactive and non-interactive materials. As the user 502 interacts with the content, the integrated user engagement and content delivery system 100 monitors engagement and dynamically introduces engaging elements like videos to maintain interest. The session concludes with the integrated user engagement and content delivery system 100 adjusting the content sequence based on user feedback and summarizing the user's performance, thereby providing a customized and effective study experience.

The sequence diagram 500 illustrates an exemplary scenario where Sophia, a college student preparing for her economics exam, begins her online learning session by interacting with the platform. She sets her session goals and specifies her available study time. This initial step involves Sophia (user) communicating her preferences and objectives to the online learning platform 102 (integrated user engagement and content delivery system 100) using the user interface 114 integrated within the online learning platform 102, establishing the parameters for the upcoming online learning session.

Following Sophia's input, the integrated user engagement and content delivery system 100 queries the content database to select the initial content sequence. This involves a sophisticated algorithm analyzing the goals and time constraints provided by Sophia to determine the most appropriate content types and difficulty levels that will optimize her learning experience. The integrated user engagement and content delivery system 100 requests a mixed set of content items from the content database 112, which processes this request and returns a customized content sequence designed to meet Sophia's study objectives. With the content sequence in hand, the integrated user engagement and content delivery system 100 begins presenting the content to Sophia on the user interface 114. The session might start with an interactive graph analysis to actively engage her right from the beginning. This initial content is chosen to align with Sophia's study goals and to captivate her interest.

As Sophia interacts with the presented content, she engages in various activities such as solving problems, watching educational videos, or answering multiple-choice questions. Throughout this interaction, the integrated user engagement and content delivery system 100 closely monitors her engagement and performance. It is during this phase that the integrated user engagement and content delivery system 100 dynamically introduces additional engaging content, such as a controversial conversation video. This is intended to maintain Sophia's interest and provide a stimulating break from traditional study methods.

Sophia provides feedback to the integrated user engagement and content delivery system 100 using the feedback module 116, either implicitly through her interaction patterns (such as time spent on each activity and her response accuracy) or explicitly through feedback mechanisms (like rating the content). The integrated user engagement and content delivery system 100 utilizes this feedback to adjust the content sequence in real-time. Suppose the integrated user engagement and content delivery system 100 detects that Sophia is struggling with a particular topic or becoming disengaged. In that case, it can modify the upcoming content to either simplify or vary the material, ensuring the session remains productive and engaging.

After the session, Sophia indicates that she has finished her study period. The integrated user engagement and content delivery system 100 then summarizes her session performance by generating a detailed report that highlights her strengths, identifies areas for improvement, and provides insights into her overall progress. This summary not only reinforces the material Sophia has covered but also offers motivation and direction for future online learning sessions.

This sequence diagram 500 showcases the online learning platform's 102 ability to adaptively curate and adjust content based on user interaction, providing a personalized and dynamic learning experience that significantly differs from traditional, static educational approaches.

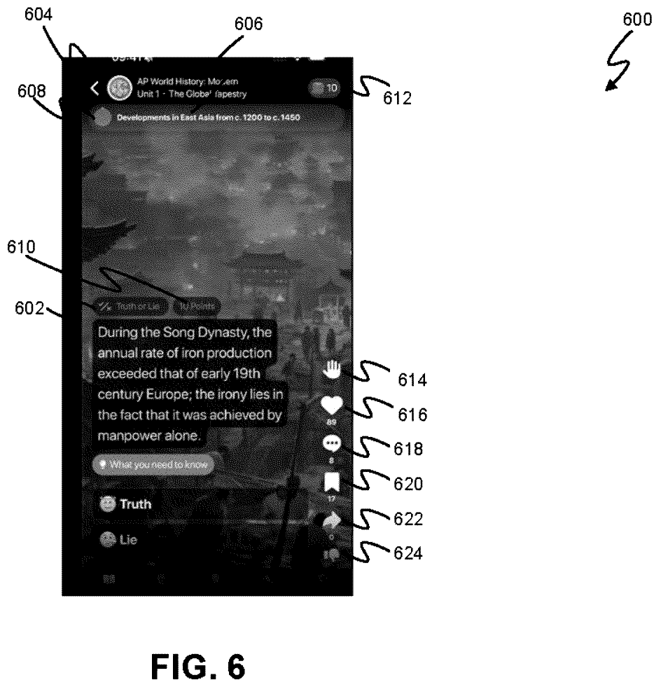

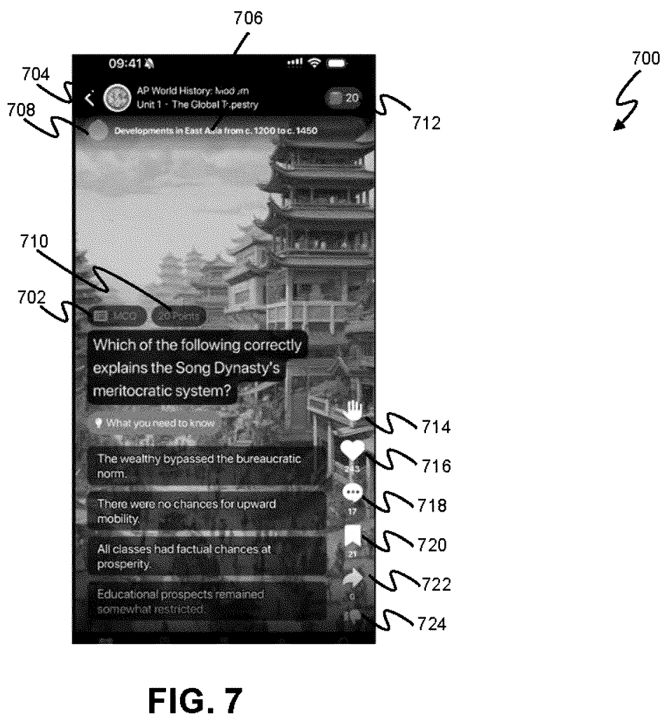

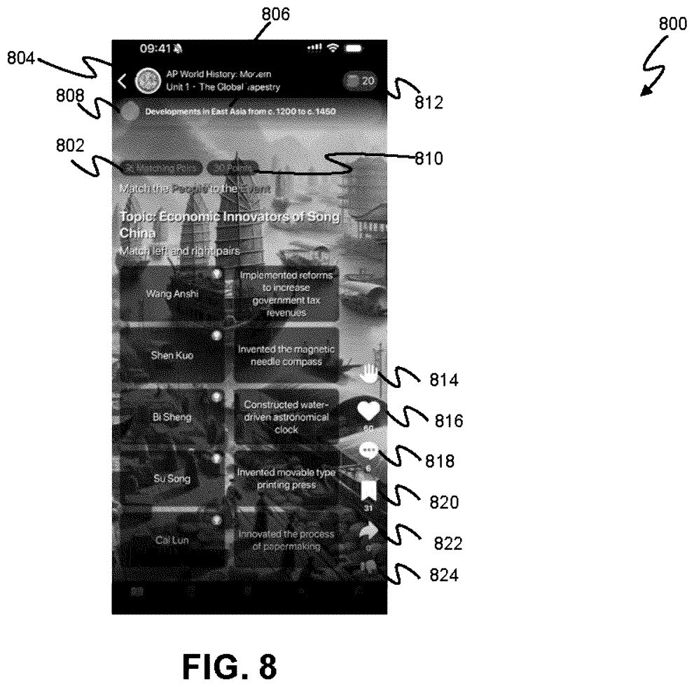

FIGS. 6-8 depict exemplary user interfaces 600, 700, and 800 of an online learning platform 102 disclosing a variety of content items provided to the user.

The user interfaces 600, 700, and 800 are accessed by the user using the online learning platform 102 installed on the user's device.

In user interface 600 a truth or lie question 602 is displayed to the user, which is to be answered by the user. Tab 604 discloses the details of the curriculum, subject, and unit. For example, in this case, it is the ‘World History: Modern’ subject from the ‘AP’ curriculum where the unit is ‘The Global Tapestry’. Tab 606 represents the topic of the selected unit ‘Developments in East Asia from c. 1200 to c. ‘1450’. The user will receive questions related to this topic only. The circle 608 beside the topic tab 606 represents how much part of the topic is completed by the user. Further, question 602 tab represents the type of question i.e., ‘Truth or Lie’, and tab 610 represents the total number of points allocated to this question i.e., ‘10 points’. If the user answers correctly, the user gets 10 points, which gets collated in the total collection shown on the top-right side of the user interface. Tab 612 represents the total points collected by the user.

Further, the user can click the tab 614 ‘hand button’ to interact with the real-time tutor using a chatbot. The user gets a real-time answer from the tutor about the queries asked by the user. The real-time tutor uses the curriculum data, and pre-stored data to provide the details of the questions asked by the user. Also, the user can like, comment, save, share, and dislike the information provided by the real-time tutor using the tabs 616, 618, 620, 622, and 624, respectively.

In the user interface 700, multiple-choice question (MCQ) tab 702 is displayed to the user, which is to be answered by the user. Tab 704 discloses the details of the curriculum, subject, and unit. For example, in this case, it is the ‘World History: Modern’ subject from the ‘AP’ curriculum where the unit is ‘The Global Tapestry’. Tab 706 represents the topic of the selected unit ‘Developments in East Asia from c. 1200 to c. ‘1450’. The user will receive questions related to this topic only. The circle 708 beside the topic tab 706 represents how much part of the topic is completed by the user. Further, tab 702 represents the type of question i.e., ‘MCQ’ and tab 710 represents the total number of points allocated to this question i.e., ‘20 points’. If the user answers correctly, the user gets 20 points, which gets collated in the total collection shown on the top-right side of the user interface. The tab 712 represents total points collected by the user.

In user interface 800 a match the following question tab 802 is displayed to the user, which is to be answered by the user. Tab 804 discloses the details of the curriculum, subject, and unit. For example, in this case, it is the ‘World History: Modern’ subject from the ‘AP’ curriculum where the unit is ‘The Global Tapestry’. Tab 806 represents the topic of the selected unit ‘Developments in East Asia from c. 1200 to c. ‘1450’. The user will receive questions related to this topic only. The circle 808 beside the topic tab 806 represents how much part of the topic is completed by the user. Further, tab 802 represents the type of question i.e., ‘Matching Pairs’ and tab 810 represents the total number of points allocated to this question i.e., ‘30 points’. If the user answers correctly, the user gets 30 points, which gets collated in the total collection shown on the top-right side of the user interface. The tab 812 represents total points collected by the user.

These are just exemplary scenarios where interactive questions like ‘Truth or Lie’, academic questions like ‘Matching Pairs’, and ‘MCQ’ is provided to the user on a rotational basis so that the user remains engaged and attentive during the whole online learning session. There may be scenarios where there may be other types of questions like fill-in-the-blanks, did you know, what's my name, controversial questions, and so on. All these content items are provided to the user in a shuffled manner so that the user does not feel overloaded by looking only at the academic content.

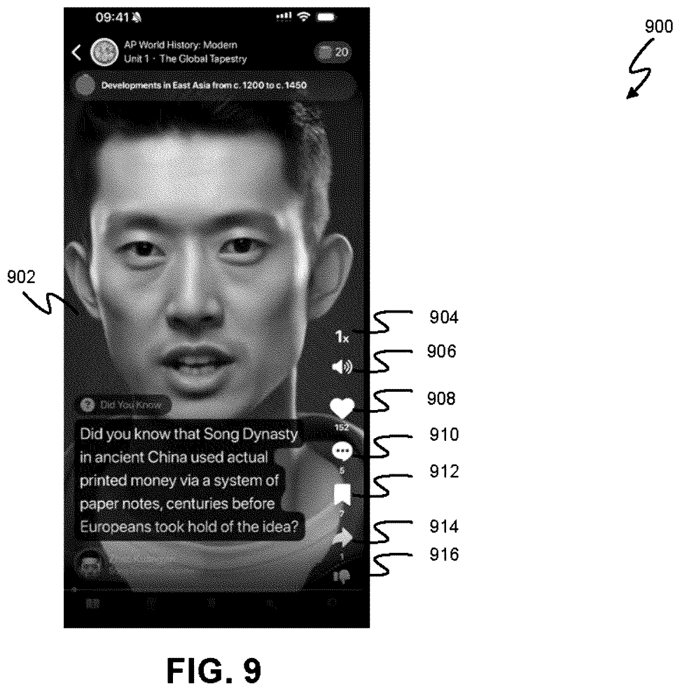

FIG. 9 depicts an exemplary view of the user interface 900 of an online learning platform 102 where a real-time tutor 902 provides adaptive learning to the user.

The user interface 900 is accessed by the user using the online learning platform 102 installed on the user's device. The user interface 900 represents a real-time tutor 902 for providing adaptive and personalized learning to the student. The real-time tutor 902 is generated in response to the question provided to the user. For instance, if the question is related to a physics topic, say gravity, then Issac Newton may act as a real-time tutor 902 and provide the information related to the question to the user. The information provided by the real-time tutor 902 is in a video format and is pre-generated.

In the user interface 900, the user is provided with an interactive question to maintain the engagement level of the user. The user can increase the speed of the video by clicking on tab 904, and pause the sound of the video by clicking on tab 906. Furthermore, the user can like, comment, save, share, and dislike the information provided by the real-time tutor 902 using tabs 908, 910, 912, 914, and 916 respectively.

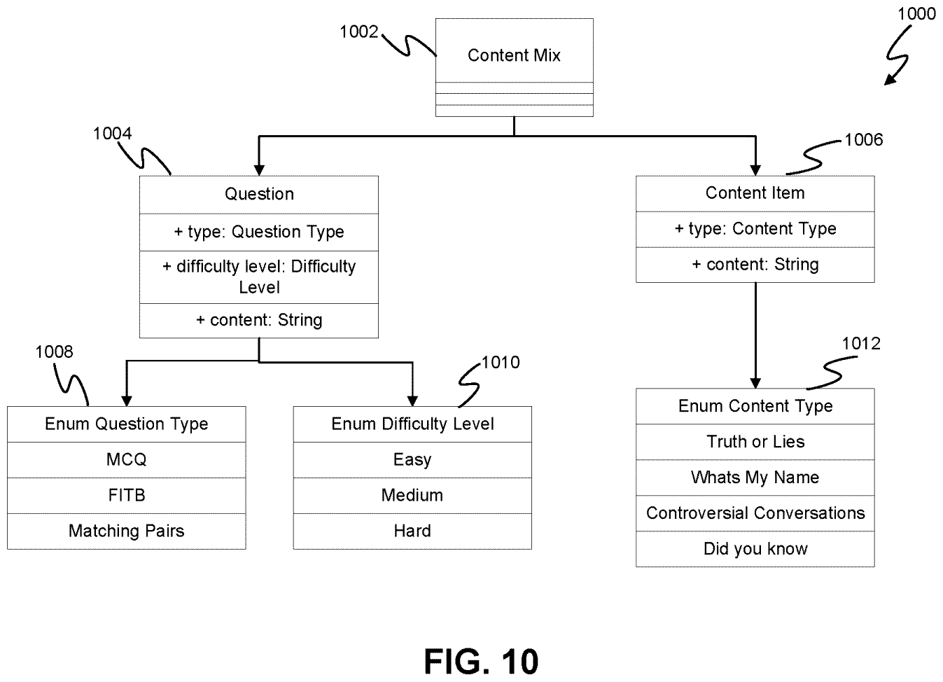

FIG. 10 depicts a data structure 1000 for storing information related to the delivery of mixed content items to optimize user learning and engagement.

The data structure 1000 is designed to store a diverse mix of educational content for the online learning platform 102, ensuring that users receive a balanced blend of interactive and non-interactive materials. At the core of this data structure 1000 is a ContentMix 1002 object, which organizes and categorizes the different types of content that will be delivered to users.

The ContentMix 1002 object contains two primary attributes: interactiveQuestions and nonInteractiveContent. The interactiveQuestions attribute is a list that stores various Question 1004 objects. These questions are designed to actively engage the user, requiring responses and promoting interactive learning. Each Question 1004 object within this list has several properties: a type that specifies the format of the question (such as multiple-choice questions (MCQ), fill-in-the-blanks (FITB), or matching pairs), a difficulty level that categorizes the question as easy, medium, or hard, and the actual content of the question itself.

The nonInteractiveContent attribute is another list within the ContentMix 1002, but it stores ContentItem 1006 object. These items represent non-interactive educational materials intended to provide information more passively. Each item in the ContentItem 1006 object is characterized by its type, which can include formats like “Truth or Lies”, “What's My Name”, “Controversial Conversations”, and “Did You Know” segments and the actual content to be presented.

The integrated user engagement and content delivery system 100 utilizes enumerations to standardize and organize the types of questions and content. The QuestionType 1008 object enumeration specifies the various formats of questions available, ensuring a structured approach to categorizing interactive elements. Similarly, the DifficultyLevel 1010 object enumeration helps in maintaining the educational experience by providing content that matches the user's skill level. The ContentType 1012 object enumeration classifies the non-interactive content, contributing to a diverse and engaging learning session.

The data organized in the data structure 1000 is used for educational content delivery by blending interactive questions with engaging non-interactive materials. This mix not only provides different learning styles but also maintains user interest and prevents fatigue, promoting an effective and enjoyable learning experience.

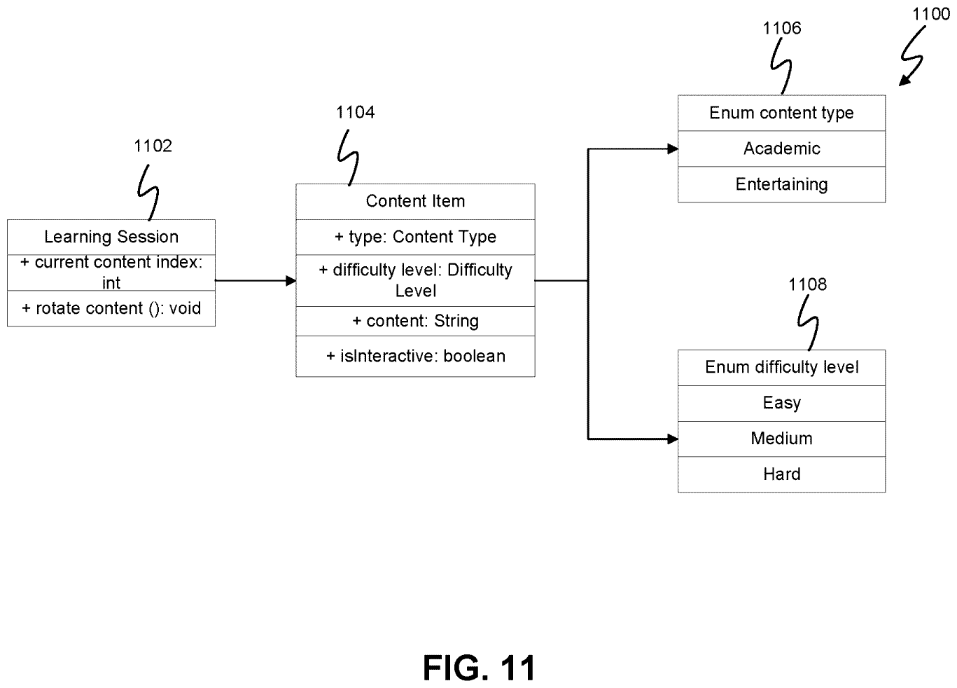

FIG. 11 depicts a data structure 1100 storing information related to optimization for enhanced learning engagement.

The data structure 1100 is utilized by learning session management system to handle various educational content. LearningSession 1102 object organizes content to be delivered to the user in a structured manner.

The LearningSession 1102 object is a unit that contains several key attributes and methods. The LearningSession 1102 object maintains a list of ContentItem 1104 objects, which represent the individual pieces of content presented during the session which allows the LearningSession 1102 object to keep track of all the content that will be displayed to the user on the user interface 114. Additionally, the LearningSession 1102 object includes an index attribute to monitor which piece of content is currently being viewed or interacted with.

Each ContentItem 1104 object represents a unit of educational material with several properties defining its characteristics. The type of content is specified indicating whether it is academic or entertaining, which includes a mix of non-academic, interactive, and non-interactive segments ensuring a mix that can keep the learner engaged. The difficulty level 1108 object stores difficulty level of each content item, categorizing the content as easy, medium, or hard, to match the user's proficiency and provide an appropriate challenge. Furthermore, each content item includes the actual material to be presented, and a Boolean attribute to denote whether the content is interactive, distinguishing between passive and active learning experiences.

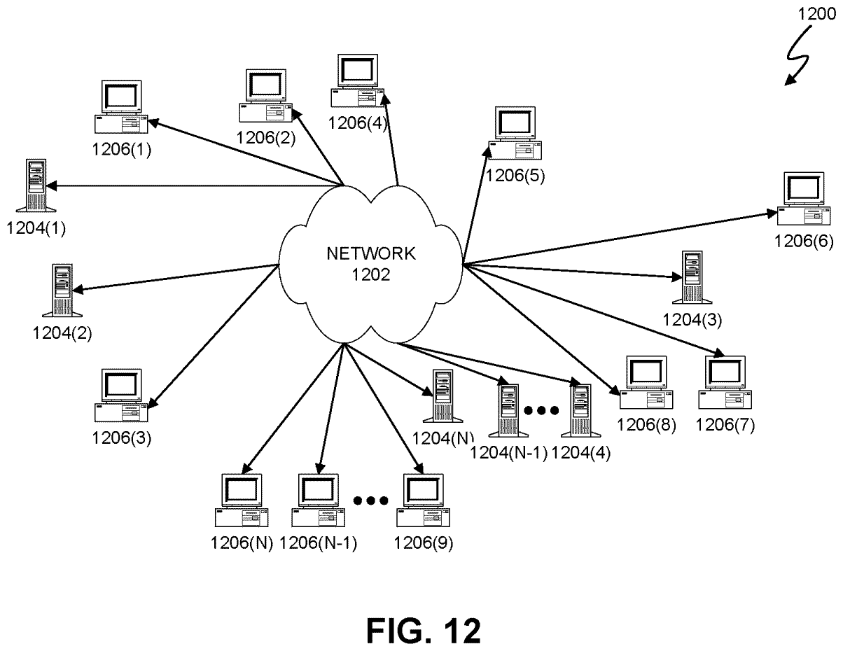

FIG. 12 is a block diagram illustrating a network environment in which an integrated user engagement and content delivery system 100 and process 200 may be practiced. Network 1202 (e.g. a private wide area network (WAN) or the Internet) includes several networked server computer systems 1204(1)-(N) that are accessible by client computer systems 1206(1)-(N), where N is the number of server computer systems connected to the network. Communication between client computer systems 1206(1)-(N) and server computer systems 1204(1)-(N) typically occurs over a network, such as a public switched telephone network over asynchronous digital subscriber line (ADSL) telephone lines or high-bandwidth trunks, for example, communications channels providing T1 or OC3 service. Client computer systems 1206(1)-(N) typically access server computer systems 1204(1)-(N) through a service provider, such as an internet service provider (“ISP”) by executing application-specific software, commonly referred to as a browser, on one of client computer systems 1206(1)-(N).

Client computer systems 1206(1)-(N) and/or server computer systems 1204(1)-(N) are specialized computers programmed to improve conventional computer systems to implement and utilize the integrated user engagement and content delivery system 100 and process 200. The type of computer system that can be specially programmed to implement and utilize the integrated user engagement and content delivery system 100 and process 200 includes a mainframe, a mini-computer, a personal computer system including notebook computers, a wireless, mobile computing device (including personal digital assistants, smartphones, and tablet computers). These computer systems are typically designed to provide computing power to one or more users, either locally or remotely. Each computer system may also include one or a plurality of input/output (“I/O”) devices coupled to the system processor to perform specialized functions. Tangible, non-transitory memories (also referred to as “storage devices”) such as hard disks, compact disk (“CD”) drives, digital versatile disk (“DVD”) drives, and magneto-optical drives may also be provided, either as an integrated or peripheral device. In at least one embodiment, the integrated user engagement and content delivery system 100 and process 200 can be implemented using code stored in a tangible, non-transient computer-readable medium and executed by one or more processors. In at least one embodiment, the integrated user engagement and content delivery system 100 and process 200 can be implemented completely in hardware using, for example, logic circuits and other circuits including field programmable gate arrays.

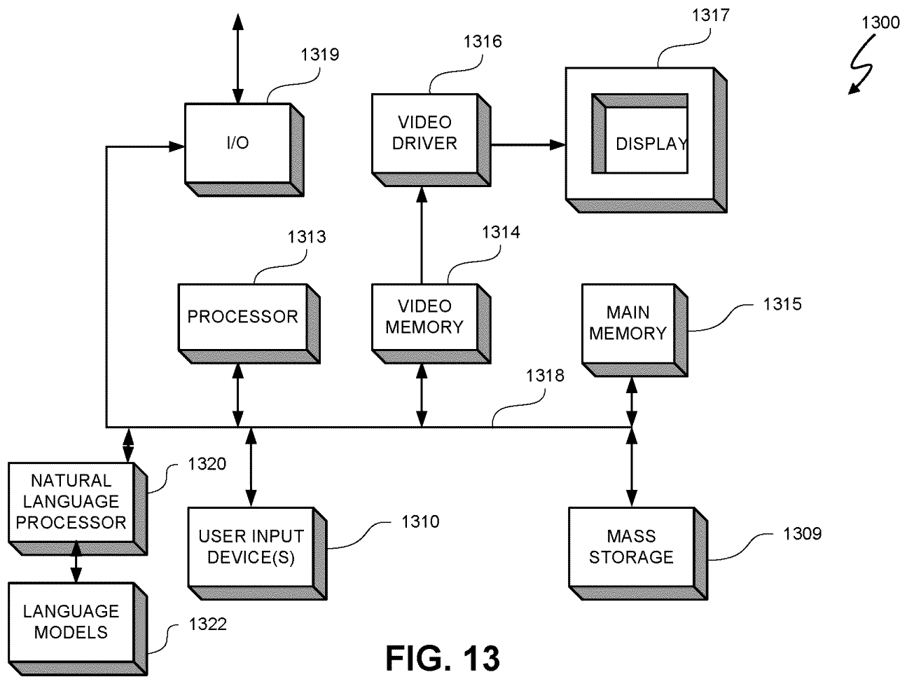

Embodiments of the integrated user engagement and content delivery system 100 and process 200 can be implemented on a computer system such as a special-purpose, special-programmed computer 1300 illustrated in FIG. 13. The input user device(s) 1310, such as a keyboard and/or mouse, are coupled to a bi-directional system bus 1318. The input user device(s) 1310 are for introducing user input to the computer system and communicating that user input to processor 1313. The computer system of FIG. 13 generally also includes a non-transitory video memory 1314, non-transitory main memory 1315, and non-transitory mass storage 1309, all coupled to bi-directional system bus 1318 along with input user device(s) 1310 and processor 1313. The mass storage 1309 may include fixed and removable media, such as a hard drive, one or more CDs or DVDs, solid state memory including flash memory, and other available mass storage technology. Bus 1318 may contain, for example, 32 of 64 address lines for addressing video memory 1314 or main memory 1315. The system bus 1318 also includes, for example, an n-bit data bus for transferring DATA between and among the components, such as CPU 1309, main memory 1315, video memory 1314, and mass storage 1309, where “n” is, for example, 32 or 64. Alternatively, multiplex data/address lines may be used instead of separate data and address lines.

I/O device(s) 1319 may provide connections to peripheral devices, such as a printer, and may also provide a direct connection to a remote server computer systems via a telephone link or to the Internet via an ISP. I/O device(s) 1319 may also include a network interface device to provide a direct connection to a remote server computer systems via a direct network link to the Internet via a POP (point of presence). Such connection may be made using, for example, wireless techniques, including digital cellular telephone connection, Cellular Digital Packet Data (CDPD) connection, digital satellite data connection, or the like. Examples of I/O devices include modems, sound and video devices, and specialized communication devices such as the aforementioned network interface.

Computer programs and data are generally stored as code in a non-transient computer-readable medium such as flash memory, optical memory, magnetic memory, compact disks, digital versatile disks, and any other type of memory. The computer program is loaded from a memory, such as mass storage 1309, into main memory 1315 for execution. Computer programs may also be in the form of electronic signals modulated in accordance with the computer program and data communication technology when transferred via a network. In at least one embodiment, Java applets or any other technology is used with web pages to allow a user of a web browser to make and submit selections and allow a client computer system to capture the user selection and submit the selection data to a server computer system.

The processor 1313, in one embodiment, is a microprocessor manufactured by Motorola Inc. of Illinois, Intel Corporation of California, or Advanced Micro Devices of California. However, any other suitable single or multiple microprocessors or microcomputers may be utilized. Main memory 1315 is comprised of dynamic random access memory (DRAM). Video memory 1314 is a dual-ported video random access memory. One port of the video memory 1314 is coupled to the video amplifier 1316. The video amplifier 1316 is used to drive the display 1317. Video amplifier 1316 is well-known in the art and may be implemented by any suitable means. This circuitry converts pixel DATA stored in video memory 1314 to a raster signal suitable for use by display 1317. Display 1317 is a type of monitor suitable for displaying graphic images.

The computer system described above is for purposes of example only. The integrated user engagement and content delivery system 100 and process 200 may be implemented in any type of computer system or programming or processing environment. It is contemplated that the integrated user engagement and content delivery system 100 and process 200 might be run on a stand-alone computer system, such as the one described above. The integrated user engagement and content delivery system 100 and process 200 might also be run from a server computer system that a plurality of client computer systems can access interconnected over an intranet network. Finally, the integrated user engagement and content delivery system 100 and process 200 may be run from a server computer system that is accessible to clients over the Internet.

Although embodiments have been described in detail, it should be understood that various changes, substitutions, and alterations can be made hereto without departing from the spirit and scope of the invention as defined by the appended claims.

What is claimed is:

1. A method to present a variety of content items during an online learning session to enhance user engagement, the method comprising:
executing code using one or more processors of a computer system to cause the computer system to perform operations comprising:
accessing user engagement data stored in a user database via an engagement analysis module integrated with an optimized content delivery system, wherein the engagement data include user's interaction with the content during the online learning session, user's content interaction history, session duration, and content type;
processing the user engagement data via the engagement analysis module to predict user engagement patterns during the online learning session;
optimizing the content items to be presented during the online learning session via an optimization module, wherein optimizing the content items includes determining sequence of content items to be presented to the user during the online learning session, shuffling the content items, and adjusting the difficulty levels of the content items based on user's proficiency level and historical performance data;
receiving the optimized content items customized based on the user's learning history, preferences, and real-time engagement to create a personalized learning experience.

2. The method of claim 1 wherein the content items include a combination of academic, non-academic, interactive, and non-interactive content.

3. The method of claim 1, wherein the content items include one or more of multiple-choice questions, fill-in-the-blanks, matching pairs, and innovative formats such as truth or lies, what's my name, controversial conversations, did you know segments, and explanatory videos to cater to different learning styles.

4. The method of claim 1, wherein the sequence of content items is customized based on user's learning history, preferences, and real-time engagement to create a personalized learning experience comprising:
updating the user profiles based on the user interactions;
analyzing the user's preferences, including preferred content types, learning styles, and difficulty levels to tailor the content sequence to the user's individual needs and preferences;
customizing the sequence of content items in real-time based on the user's current engagement metrics, performance, and feedback.

5. The method of claim 1, wherein sequence of interactive content with non-interactive content is provided to prevent mental fatigue to the user comprising:
identifying one or more breakpoints within the online learning session to introduce non-interactive content segments based on factors such as session duration, user engagement metrics, and content complexity;
providing the non-interactive content segments to the user and determining the frequency of interruptions made by the user based on user preferences, session goals, and learning objectives;
monitoring user's response to the non-interactive content segments and gathering feedback for alleviating mental fatigue and enhancing the overall learning experience.

6. The method of claim 1, wherein one of the content items include non-interactive content segments including informative videos, explanatory text, or visual aids that provide supplementary information related to the learning objectives and are informative and engaging, offering users valuable insights into the subject matter without requiring active user participation.

7. The method of claim 1 wherein processing the collected engagement data and determining the sequence of content items to be presented during the online learning session comprises:
processing the collected real-time user engagement data to understand user engagement patterns and learning behaviors and selecting content items from a pre-defined content database based on the processed data, considering the type of content, difficulty level, and relevance to the user's learning objectives;
sequencing the selected content items in an order that optimizes the user's learning experience by shuffling through different content types and varying difficulty levels;
adjusting the content items in real-time based on real-time user interactions and feedback during the online learning session, ensuring content relevance and engagement throughout the online learning session.

8. The method of claim 1 wherein by balancing the ratio of interactive to non-interactive content segments, the user engagement is optimized and the risk of cognitive overload is eliminated, thus providing an engaging and adaptive learning environment.

9. A system to present a variety of content items during an online learning session to enhance user engagement, the system comprising:
one or more processors;
memory, operatively coupled to the one or more processors consisting of one or more codes that when executed cause the one or more processors to perform operations comprising:
accessing user engagement data stored in a user database via an engagement analysis module integrated with an optimized content delivery system, wherein the engagement data include user interactions with the online learning platform, content interaction history, session duration, and content type;
processing the user engagement data via the engagement analysis module to predict engagement patterns of the user during the online learning session;
optimizing the content items to be presented during the online learning session via an optimization module, wherein optimizing the content items includes determining sequence of content items to be presented to the user during the online learning session, shuffling the content items, and adjusting the difficulty levels of the content items based on user's proficiency level and historical performance data;
receiving the optimized content items customized based on the user's learning history, preferences, and real-time engagement to create a personalized learning experience.

10. The system of claim 9 further comprises:
a user interface integrated within an online learning platform that displays the generated content items.

11. The system of claim 9 wherein the relevance of the content items is evaluated to the user's learning objectives and the content sequence is dynamically adjusted based on relevance scores, ensuring that the learning experience remains focused and aligned with user goals.

12. The system of claim 9 wherein user's preference is updated in real-time based on ongoing interactions and user feedback during the online learning session, ensuring that the received content items remain aligned with user's evolving learning needs and interests.

13. The system of claim 9 further comprises:
a machine learning module configured to train predictive models using aggregate user data to recognize engagement patterns and optimize content variety.

14. The system of claim 9 wherein the optimized content delivery system is configured to dynamically adjust the sequence of content items based on engagement analysis, ensuring continuous user engagement and preventing content fatigue.

15. The system of claim 9 wherein the distribution of content items, including interactive and non-interactive segments, is balanced, to provide a diverse and engaging learning experience while avoiding user fatigue and cognitive overload.

16.

17. The system of claim 9 further comprises:
a feedback module configured to collect user feedback on content relevance, engagement levels, and perceived difficulty, and use this feedback to iteratively improve the content sequencing capabilities.
